(19) United States
(12) Patent Application Publication
(10) Pub. No.: US 2002/0071636 A1
(43) Pub. Date: Jun. 13, 2002

(54) Method and apparatus for attaching an optical fibre to an optical device

(76) Inventors: Michael Bazylenko, Australian Tech. Park (AU); Bruce Leonard Board, Australian Tech. Park (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/917,580

(22) Filed: Jul. 27, 2001

(30) Foreign Application Priority Data
Nov. 28, 2000 (AU) PR1742

(51) Int. Cl. G02B 6/30; G02B 6/26

(52) U.S. Cl. 385/49; 385/52

(57) ABSTRACT

A method of fabricating an optical fiber alignment structure for an optical device fabricated on the surface of a substrate, the integrated optical device being adapted to be optically coupled to an end of an optical fiber. The method comprises the steps of: (a) forming a sacrificial structure of a predetermined shape on a surface of a planar substrate, wherein the predetermined shape is chosen to be an inversion of a desired shape of the alignment structure to be fabricated; (b) fabricating the optical device on the substrate such that the sacrificial structure faces a waveguide portion of the optical device; (c) etching an optical fiber insertion aperture into said substrate, such that the optical fiber insertion aperture is aligned substantially underneath the sacrificial structure; and (d) selectively etching said sacrificial structure so as to form a region shaped to receive and align an end of an optical fiber, whereby the alignment structure of the desired shape is fabricated. The method can be used to align an optical fiber to a planar waveguide.

### FIELD OF THE INVENTION

The present invention relates to a method and apparatus for optically coupling an optical fibre to an integrated optical device and to a method of production of such an apparatus.

### BACKGROUND OF THE INVENTION

The global demand for communications bandwidth has increased dramatically in recent years. Some of this increase has been due to increased telephone, fax machine and mobile telephone usage. However, for the most part it has been caused by the rapid, and increasing uptake of internet technology in the form of email, the world wide web and video conferencing etc. Optical networking technology is one area of technology that may address the increasing demand for communications bandwidth in the future.

In addition to optical transmission links between the various elements of a communications system, optical networking also requires optical components to provide switching, multiplexing and other functions within the communication network. Optical and optoelectronic components providing this functionality can be integrated into a single device and fabricated monolithically on a substrate such as silicon wafer.

Such integrated optical devices typically comprise a silicon substrate, on top of which layers of material are sequentially deposited and etched away in order to fabricate waveguides, switches, semi-conductor diode lasers and other elements comprising the optical circuit.

One of the key difficulties in providing an optical network is the interconnection between the various elements. For optical components integrated onto the same chip interconnection is achieved by the provision of a waveguide, which is fabricated into the chip along with the other components. In some cases the interconnection distance is greater, requiring interconnection through either free space transmission if the separation between devices is low, or using optical fibres if the transmission distance is long or is not a “line of sight” path.

During transmission of an optical signal, loss will occur through a combination of attenuation in the transmission path, radiation losses, and losses caused through coupling one element to the next. Thus, when making a connection between an optical fibre and another optical component such as an integrated optical device, the loss should be minimised in order to reduce this component of the overall loss of the system.

Further, when attaching a fibre to a waveguide, it is very important to ensure that accurate mechanical alignment is achieved and high levels of mechanical support are given to the fibre during attachment to the waveguide.

One of the most important aspects of minimising loss when coupling an optical fibre to a light transmission medium in an adjoining device is the alignment between the end of the optical fibre and the adjoining device. If the end of the optical fibre, or the adjoining surface of the optical device is not planar, or if the end of the optical fibre is not kept parallel to the end of the adjoining light transmission means, a gap will be present between the fibre and the adjoining light transmission means, leading to increased loss in the desired transmission direction and possibly increased reflected power in the opposite direction due to reflection at the interfaces with the gap. Similarly if lateral alignment is not achieved, ie if the centres of the fibre and adjoining light transmitting medium are not coaxial, loss will also increase.

Prior art methods of coupling optical fibres to integrated optical devices have typically required external means for accurately aligning the end of the fibre with the device. Furthermore, most coupling means have required the optical fibre to be coupled at the edge of the device, thereby limiting the design of optical circuitry on the chip.

### SUMMARY OF THE INVENTION

An object of the present invention is to provide an optical fibre alignment structure and an optical device incorporating an optical fibre alignment structure, a method of fabricating an optical fibre alignment structure, and a method of optically coupling an optical fibre to an optical device that may partially ameliorate at least one of the abovementioned disadvantages.

According to a first aspect of the present invention there is provided a method of fabricating an optical fibre alignment structure for aligning and optically coupling an end of an optical fibre to a planar optical device, said method comprising the steps of:

(a) forming a sacrificial structure of a predetermined shape on a surface of a planar substrate. wherein the predetermined shape is chosen to be an inversion of a desired shape of the alignment structure to be fabricated;

(b) fabricating the optical device on the substrate such that the sacrificial structure faces a waveguide portion of the optical device;

(c) etching an optical fibre insertion aperture into said substrate such that the optical fibre insertion aperture is aligned substantially underneath the sacrificial structure; and

(d) selectively etching said sacrificial structure so as to form a region shaped to receive and align an end of an optical fibre, whereby the alignment structure of the desired shape is fabricated.

The term “inversion” is used here to described a shape which is a negative of another shape, in the sense that a mould has a shape which is an inversion of a shaped formed from the mould.

Preferably, said waveguide is a planar waveguide and step (b) includes the step of integrally fabricating a coupling structure with said planar waveguide, said coupling structure adapted to couple light between said optical fibre and said waveguide.

Preferably the coupling structure includes one or more of a group comprising: a metallised mirror; a partially transmissive mirror; a MEMS switch element; an electro-optic polymer material; space switch; a grating; or thin film dielectric material It is also preferable that step (b) is preceded by an additional step of, forming alignment marks on said substrate, wherein said alignment marks determine the position of said optical fibre insertion aperture.

In a further preferred embodiment step (c) is preceded by an additional step of, performing photolithography on a back surface of said substrate to define the position of an optical fibre insertion aperture in alignment with said alignment marks.

According to a second aspect of the present invention there is provided an optical fibre alignment structure fabricated using a method as described above.

According to a third aspect of the present invention there is provided an optical device including an optical fibre alignment structure fabricated using a method as described above.

According to a fourth aspect of the present invention there is provided a method of optically coupling an end of an optical fibre to an optical device, said optical device being fabricated on a top surface of a silicon substrate and including an optical fibre alignment structure as described above, said method including the steps of;

(a) partially inserting the end of said optical fibre into an optical fibre insertion aperture in said substrate until the end of said fibre contacts said optical fibre alignment structure; and

(b) continuing insertion of said optical fibre, such that the end of said optical fibre is guided by said optical fibre alignment structure, until correct alignment of the end of said optical fibre is attained with respect to said integrated optical device.

Preferably step (a) is preceded by the additional step of inserting the end of said optical fibre in a fibre support sleeve or ferrule.

Preferably the method includes the additional step of affixing said fibre in the attained position.

In at least one embodiment, the optical coupling can be adjusted to prevent feedback effects from reflections at the fiber/waveguide interface.

It is also preferable that a step of hermetically sealing a void between the optical fibre alignment structure and the optical fibre is performed.

In a fifth aspect, the invention provides an optical fibre alignment assembly for aligning and optically coupling an end of an optical fibre to a planar optical device, the alignment assembly comprising a substrate, an aperture formed through said substrate for receiving said optical fibre therein, and an end-receiving structure shaped to receive an end of said optical fibre inserted through said aperture and to align said optical fibre end with respect to a waveguide portion of said optical device.

Preferably the end-receiving structure comprises an inwardly tapered side wall for urging alignment of an optical fibre with said waveguide portion.

Preferably the end-receiving structure comprises formations complimentary to formations on an end of an optical fibre to be received by said structure.

In a sixth aspect, the invention provides in an integrated optical structure comprising a substrate, an optical device formed on said substrate, an aperture formed through said substrate for receiving an optical fibre therein and an end-receiving structure shaped to receive an end of an optical fibre inserted through said aperture and to align said optical fibre end with a waveguide portion of said optical device.

### BRIEF DESCRIPTION OF THE DRAWINGS

Notwithstanding any other forms which may fall within the scope of the present invention, preferred forms of the invention will now be described, by way of example only with reference to the accompanying drawings in which:

FIG. 1 shows a cross sectional view of a silicon substrate on which a sacrificial fibre alignment structure has been deposited;

FIG. 2 shows a cross sectional view of the structure of FIG. 1 on which additional layers of material have been deposited forming a silica-based planar waveguide structure on top of a silicon substrate;

FIG. 2a shows a cross sectional view of a modified embodiment;

FIG. 3 shows a cross sectional view of the optical device of FIG. 2 with a layer of photo resist deposited on the bottom surface of the silicon substrate;

FIG. 4 shows a cross sectional view of the optical device after back etching has been performed on the structure;

FIG. 5 shows a cross sectional view of the optical device of the preceding figures connected to an optical fibre;

FIG. 6 shows a plan view of the bottom of an integrated optical device including a fibre alignment structure according to an embodiment of the invention;

FIG. 7 shows a cross sectional view of a further embodiment of an integrated optical device according to the invention;

FIG. 8 shows a cross sectional view of a silicon substrate with a section of mask thereon;

FIG. 9 shows a cross sectional view of the substrate of FIG. 8 after etching;

FIG. 10 shows a cross sectional view of the substrate of FIG. 9 with a waveguide deposited on the top surface and a mask applied to the lower surface;

FIG. 11 shows a cross sectional view of the structure of FIG. 10 after back etching; and

FIG. 12 shows a cross sectional view of the structure of FIG. 11 when connected to an optical fibre.

### DETAILED DESCRIPTION OF THE EMBODIMENTS

The following embodiments describe an optical fibre alignment structure and a method for its fabrication, as well as a method for optically coupling an optical device to an optical component including such a structure. The optical fibre alignment structure is fabricated on a substrate material by forming a sacrificial blank with a shape chosen to be an inversion of the optical fibre alignment structure on the surface of the substrate, then fabricating the remainder of the integrated optical device over the top of this structure. Once the optical device is completed, an optical fibre insertion aperture and the sacrificial blank are etched away, leaving the desired optical fibre alignment structure and an aperture for receiving an optical fibre.

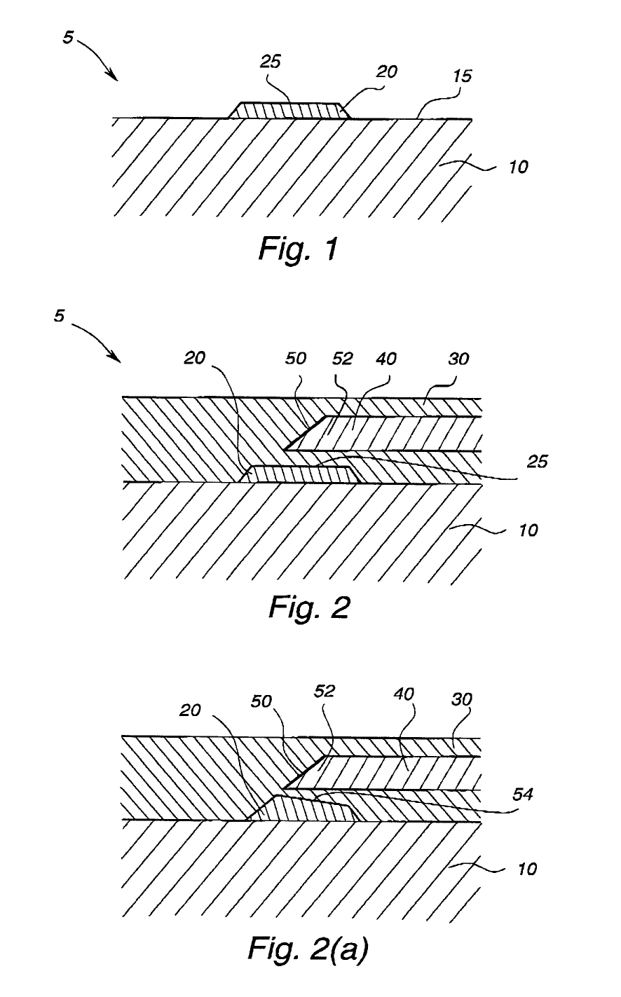

FIG. 1 shows a cross sectional view of an optical device during an early stage of fabrication. As will be known to the person skilled in the art, integrated optical devices can be fabricated on silicon wafer substrates in much the same way as semiconductor devices are fabricated.

The device 5 shown in FIG. 1 comprises a silicon wafer substrate 10 on top of which has been deposited a sacrificial structure 20. Sacrificial structure 20 is shaped so as to form an inversion of a fibre alignment structure, also referred to herein as an end-receiving structure, which is to be etched away during the penultimate step of the fabrication process. Sacrificial structure 20 is fabricated from a material which can easily be selectively etched (i.e. can be etched in preference to other materials such as silica-based materials) and is generally shaped in the form of a frustrum of a cone. For example, the sacrificial structure can be formed from amorphous silicon. The top surface 25 of structure 20 is generally planar and in this embodiment lies parallel to the top surface 15 of wafer 10.

In addition to forming the sacrificial structure 20 it is also possible to form one or more alignment marks on either the substrate 10 or structure 20 which can advantageously be used at a later stage of the method to align a photolithography mask for back etching the substrate 10.

Turning now to FIG. 2, which shows the integrated optical device 5 after additional fabrication steps have been performed. The device 5 now comprises the silicon substrate 10 on top of which are formed structure 20, numerous layers of silicon dioxide (SiO₂) 30 into which have been fabricated a silica-based planar waveguide 40, and a metallised mirror 50 at a terminal end 52 of the waveguide 40. The metallised mirror 50, silica layers 30 and waveguide 40 may be formed using any suitable technique as will be known to a person skilled in the art. The mirror 50 can be a metallised surface made from a highly reflective material such as aluminium or gold, which can be deposited by sputtering. A suitable technique for fabricating a structure including a metallised mirror, is disclosed in Patent Cooperation Treaty Patent Application No. PCT/AU95/00811 entitled “Fabrication of Silica-Based Optical Devices and Opto-Electronic Devices”.

The top surface 25 of the sacrificial structure 20 faces the mirror 50 and terminal end 52 of the waveguide 40. Advantageously the metallised mirror 50 will be angled at 45° to the plane of the wafer surface 15 such that light incident on the mirror is reflected along planar waveguide 40. Additionally, it is advantageous that the mirror 50 is aligned with the centre of structure 20.

Alternatively the mirror 50 can be fabricated such that it is partially transmissive (e.g. 1% to 5% transmissive) to allow additional functions to be performed other than just reflection. For example, a photodetector can be placed behind and or beyond a partially transmissive mirror to perform a permanent output power monitoring function. A further alternative to depositing the metallised mirror 50 on this 45° surface is to mount a MEMS switch element.

In a further embodiment an electro-optic polymer material can be substituted for the metallised mirror 50 in order to provide space switching, as per the above, or on-off switching. In a further alternative embodiment a grating or thin film dielectric material can be used in place of the metallised mirror 50 to provide a grating and or filter function.

Again, further alignment marks, either in addition to alignment marks laid down in step 1. or as an alternative to those alignment marks, can be formed in order to facilitate alignment of the photolithography mask used in the next step of fabrication of the device.

In FIG. 2a there is illustrated a modification of the arrangement of FIG. 2 which is provided so as to suppress back reflections. In this modification, the top surface 54 is profiled so that is at an angle relative to the waveguide 40 and substrate 10. The angle is preferably about 7° to 12° from the horizontal.

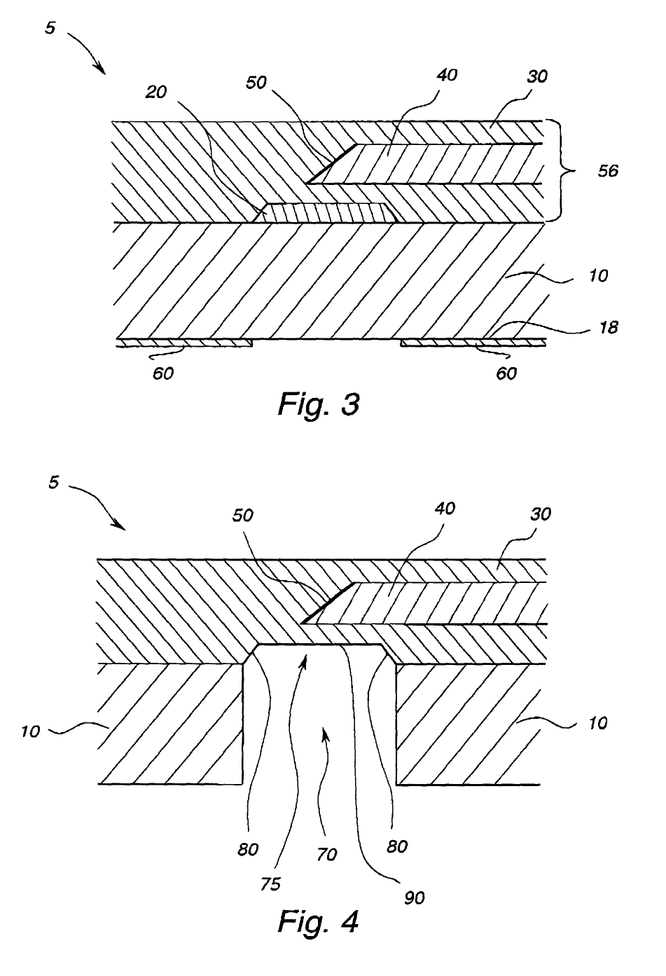

FIG. 3 shows the integrated optical device of FIG. 2 having a completed superstructure 56 fabricated on top of sacrificial structure 20 and silicon substrate 10. The bottom surface 18 of substrate 10 is partially covered by areas of photoresist 60. These regions of photoresist 60 have been laid down using a photolithography process. A suitable photolithographic technique to apply photo resist in the desired pattern will be know to a person skilled in the art. During the photolithography process the mask used to form layer 60 can advantageously be aligned with the alignment marks which may have been deposited during the steps described above. In a particularly advantageous embodiment the alignment marks on the top surface of the substrate will be readable through the substrate using infrared light.

Once the photoresist has been deposited, a back etch can be performed through the substrate 10 and into sacrificial structure 20. FIG. 4 shows the integrated optical device 5 after the back etch has been performed. The back etching process has etched a hole through substrate 10 and also etched away the sacrificial structure, to leave an optical fibre insertion cavity 70, which ends in an optical fibre alignment structure 75 for receiving and aligning an end of an optical fibre.

The optical fibre alignment structure 75 includes a tapered annular edge 80 and planar circular central region 90. The central circular region 90 should have a diameter close to or equal to the diameter of the core of an optical fibre which is to be inserted into the optical fibre insertion cavity 70. Circular planar region 90 is surrounded by the angled annular edge 80 which, in use, acts to guide the end of an inserted optical fibre into a position of correct alignment such that an end of the fibre core abuts against the circular planar region 90.

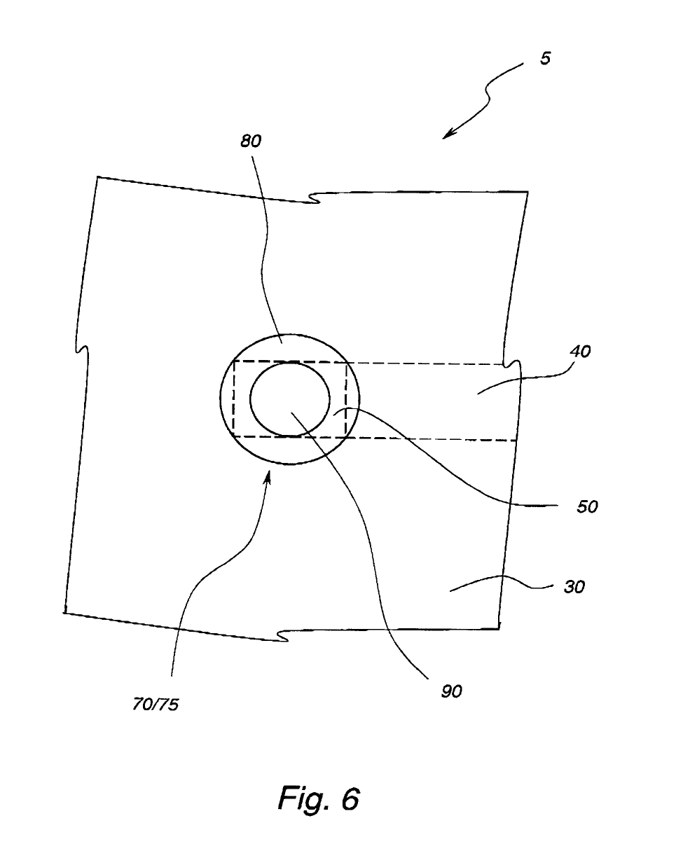

It can be seen that when an incorrectly-aligned fibre is inserted into the optical fibre insertion cavity 70, the fibre will first come into contact with a portion of the tapered edge 80 of the fibre alignment structure 75. With continued insertion, the fibre will be guided by the tapered edge 80 until its end is against the planar surface 90. A plan view of the fibre alignment structure 75 and its alignment relative to the 45° metallised mirror 50 can be seen in FIG. 6.

FIG. 6 shows a plan view of the optical device of FIGS. 1 to 4 from its underside. Although in practice the planar waveguide 40 and the metallised mirror 50 will not be visible, their positions have been shown in FIG. 6 in dashed lines to highlight the correct alignment of the metallised mirror 50 with the fibre alignment structure 75 and their relationship to the planar waveguide 40.

It can be seen that the tapered edge 80 and central planar portion 90 of the fibre alignment structure 75 are coaxial with each other and that this axis lies substantially in the centre of the metallised mirror 50 of the optical device 5. This alignment is important, as misalignment of the fibre with the metallised mirror will mean that light incident on the mirror from the planar waveguide may not be coupled into the fibre if the misalignment is so severe that the incident light does not fall within the numerical aperture of the optical fibre, or that a large proportion of the light emitted from the end of the optical fibre will miss the surface of the mirror 50 and thus not be coupled into the planar waveguide 40.

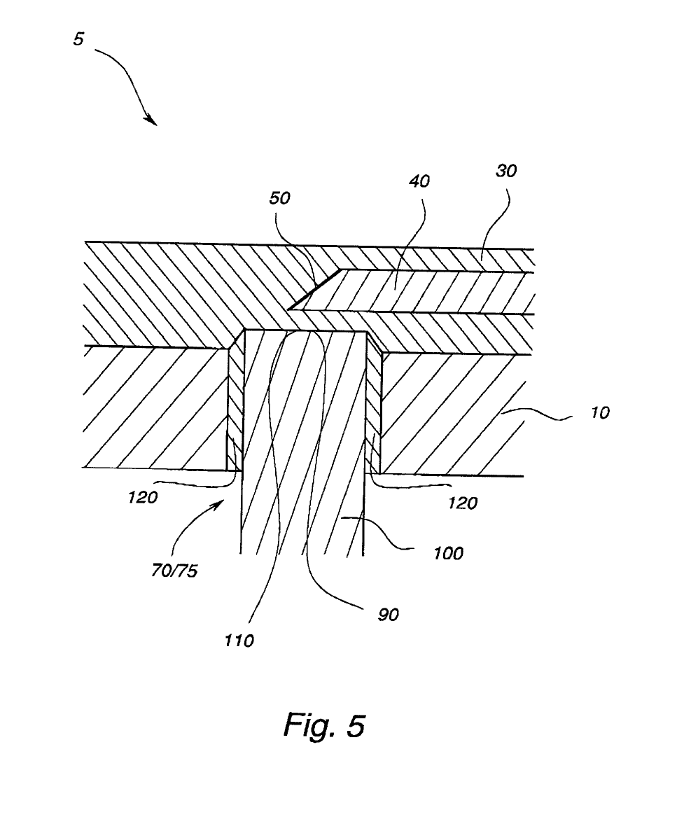

FIG. 5 shows the optical device 5 as described above when coupled to an optical fibre 100. The optical fibre 100 is inserted into the optical fibre insertion cavity 70 until its planar end surface 110 is in abutment with the planar circular surface 90 of the fibre alignment structure 75.

If the fibre end surface 110 is orthogonal to the direction of the light incident on it, then backreflections from the surface in a silica glass-to-air interface will be −14 dB to −15 dB below the incident power level. That is, about 3% to 4% of light will be reflected off this surface. As well as causing inefficiency in the system, the reflected power can cause problems by being coupled back into the waveguide 40.

In a preferred embodiment of the invention the end surface 110 of the fibre 100 is angled to minimise backreflections back towards the mirror 50. The fibre endface 110 may be cleaved and/or polished to an angle. The optimum angle is wavelength-dependent, as will be known to a person skilled in the art. For example, for a light source of 1550 nm and standard single mode fibre, the optimum angle is approximately 8° from the orthogonal.

The planar circular surface 90 of the alignment structure 70 can also be angled at an angle matching that of the fibre end.

Once the fibre is correctly aligned as described above, it is advantageous to form a hermetic seal 120 between the substrate 10 and the optical fibre 100 using an epoxy material, UV-cured acrylic adhesive, cyanoacrylic adhesive or other suitable substance. Forming a hermetic seal 120 between the fibre 100 and the substrate 110 forms the dual purpose of holding the optical fibre in position and making the coupling moisture resistant.

By etching two (or more) holes and corresponding alignment structures, it is possible to accommodate two (or more) fibres (or ferruled fibres) and switch the output between each of the plurality of fibres using a suitable switching means in place of the metallised mirror 50.

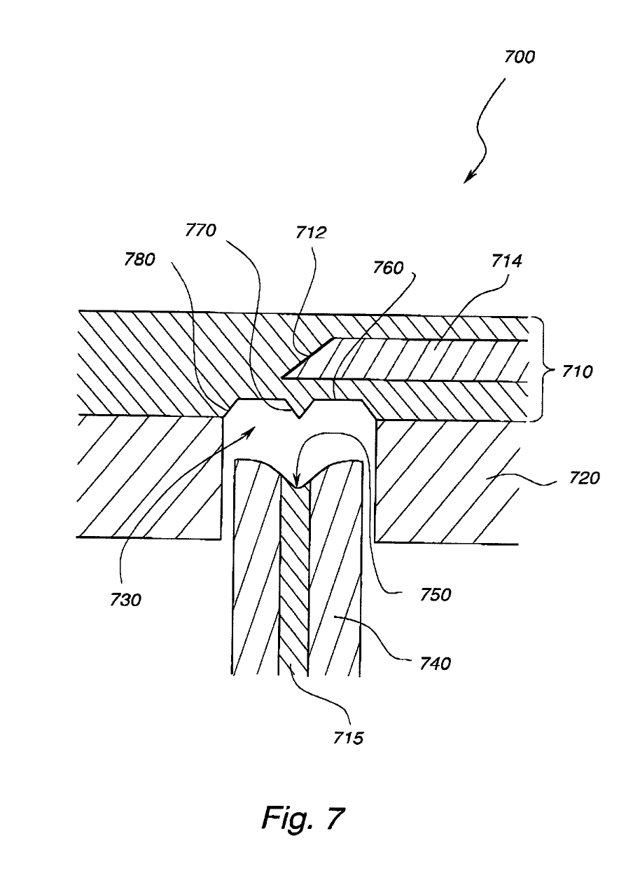

FIG. 7 shows an embodiment of the present invention adapted for connection to an optical fibre having a fibre ferrule 740 or other type of fibre support sleeve. FIG. 7 shows a planar waveguide structure 710 including a 45° metallised mirror 712 and waveguide 714 fabricated on a substrate 720. During fabrication of the fibre alignment structure 730, a sacrificial blank (not shown) similar to the sacrificial blank (20) described in relation to FIGS. 1 to 3 is deposited on the substrate 720. Alternatively, as illustrated later, the sacrifical blank can be etched into the surface of the wafer. Substrate 720 is back etched to form a fibre insertion aperture and to remove the sacrificial blank, thereby forming fibre alignment structure 730. The fibre alignment structure includes a bevelled annular surface 780 for guiding the fibre end into position, and a generally planar, inner annular region 760. Additionally, the fibre alignment structure 730 includes a formation in the form of protrusion 770 arranged to cooperate with the end of a fibre ferrule 740. The protrusion 770 is formed by forming the sacrificial blank with the appropriate shape. The alignment structure can alternatively include a differently-shaped formation, such as a depression shaped to received a pointed end of a fibre. In a simplified embodiment, the formation can be dispensed with.

In this embodiment the optical fibre 715 is sheathed by a fibre support sleeve or ferrule 740. Fibre ferrule 740 has a machined end with an indent 750 having a complimentary shape to protrusion 770 of the fibre alignment structure 730. In use, the indent 750 of the ferrule 740 cooperates with protrusion 770 to assist the bevelled annular surface 780 of the fibre alignment structure 730 to correctly align the optical fibre 715 with the planar waveguide 705 of the arrangement 700.

This embodiment advantageously provides additional mechanical support for the fibre, a larger surface area for permanent attachment (ie. bonding by some means), protection for the fibre tip, and an additional means for keying the alignment. The fibre ferrule also allows simpler polishing of an angle on the fibre endface using standard angled connector polishing techniques. It is preferable that a small diameter ferrule, for example an MU ferrule, is used to minimise mass. Alternatively, a 1 mm diameter glass ferrule can be used.

As will be clear to a person skilled in the art, the present invention is applicable to a fibre having a connector ferrule made from any suitable material, or any other fibre support sleeve, as well as to an arrangement utilising a bare fibre. However, in the embodiment of FIG. 7 it is preferable that the ferrule 740 is made from mechanically suitable material with a thermal expansion coefficient closely matched to that of the substrate 720 of the structure 710, in order to better match the thermal expansion coefficients of the rest of the arrangement.

It will be understood that the invention disclosed and defined herein extends to all alternative combinations of two or more of the individual features mentioned or evident from the text or drawings. All of these different combinations constitute various alternative aspects of the invention.

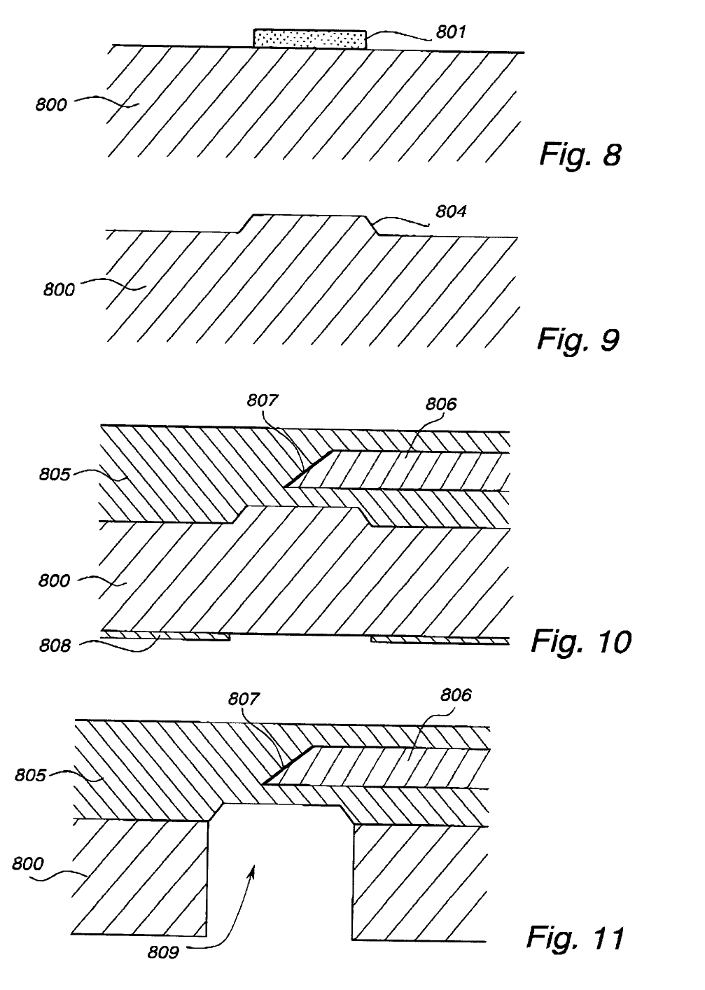

For example, turning now to FIG. 8 to FIG. 11, there is illustrated an alternative series of manufacturing steps for implementation of the present invention. Initially, as illustrated in FIG. 8 a wafer substrate 800 is masked 801. Subsequent anisotropic etching in KOH results in 60° profiled edges 804. Subsequently, as illustrated in FIG. 10, a series of layers are deposited in accordance with the teachings of the aforementioned PCT application including silicon dioxide layer 805, waveguide layer 806 and mirror portions 807. Next the back surface of the wafer is masked 808 for back etching so as to produce the fiber insertion cavity 809 shown in FIG. 11.

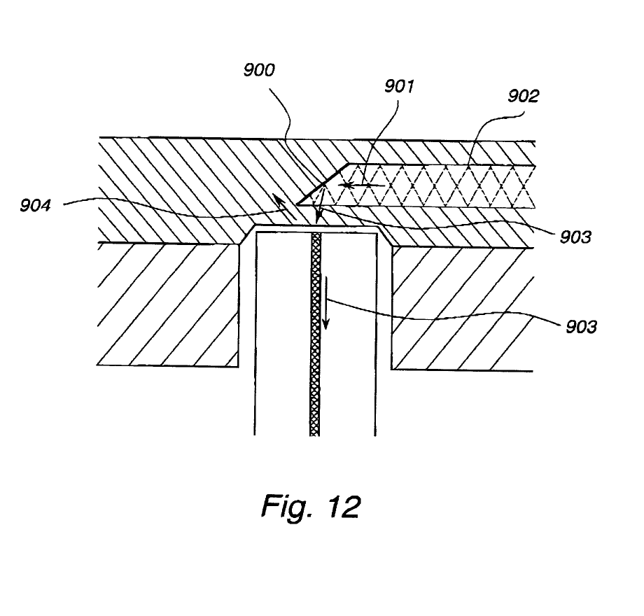

A number of further modifications are also possible. For example, as shown in FIG. 12, by utilising processing steps the angle of the mirror 900 can be adjusted such that the light 901 being transmitted along the waveguide 902 is reflected along path 903. Any back reflections 904 are then reflected away from the surface of the mirror 900 so as to reduce the opportunities for feedback to enter the waveguide 902. In a further modification, the mirror surface can be implemented via an electro-optic material switching structure (for example, a polymer material) which changes the angle of reflection depending on an external electric field.

It will be appreciated by the person skilled in the art that numerous modifications and/or variations may be made to the present invention as shown in the specific embodiments without departing from the spirit or scope of the invention as broadly described. The present embodiments are, therefore, to be considered in all respects illustrative and not restrictive.

We claim:

1. A method of fabricating an optical fibre alignment structure for aligning and optically coupling an end of an optical fibre to a planar optical device, said method comprising the steps of:
(a) forming a sacrificial structure of a predetermined shape on a surface of a planar substrate, wherein the predetermined shape is chosen to be an inversion of a desired shape of the alignment structure to be fabricated;
(b) fabricating the optical device on the substrate such that the sacrificial structure faces a waveguide portion of the optical device;
(c) etching an optical fibre insertion aperture into said substrate such that the optical fibre insertion aperture is aligned substantially underneath the sacrificial structure; and
(d) selectively etching said sacrificial structure so as to form a region shaped to receive and align an end of an optical fibre, whereby the alignment structure of the desired shape is fabricated.

2. A method of fabricating an optical fibre alignment structure for an integrated optical device as claimed in claim 1 wherein said waveguide is a planar waveguide and step (b) includes the step of integrally fabricating a coupling structure with said planar waveguide, said coupling structure adapted to couple light between said optical fibre and said waveguide.

3. A method of fabricating an optical fibre alignment structure for an integrated optical device as claimed in claim 2 wherein said coupling structure includes one or more of a group comprising:
a metallised mirror, a partially transmissive mirror; a MEMS switch element; an electro-optic polymer material; a polymer filter; space switch; a grating; or thin film dielectric material.

4. A method of fabricating an optical fibre alignment structure for an integrated optical device as claimed in claim 1, wherein step (b) is preceded by an additional step of, forming alignment marks on said substrate, wherein said alignment marks determine the position of said optical fibre insertion aperture.

5. A method of fabricating an optical fibre alignment structure for an integrated optical device as claimed in claim 4 wherein step (c) is preceded by an additional step of performing photolithography on a second surface of said substrate to define the position of an optical fibre insertion aperture in alignment with said alignment marks.

6. An optical fibre alignment structure fabricated using a method as claimed in claim 1.

7. A method of optically coupling an end of an optical fibre to an optical device formed on a substrate, said method including the steps of:
(a) partially inserting the end of said optical fibre into an optical fibre insertion aperture in said substrate until the end of said fibre contacts an optical fibre alignment structure disposed between the substrate and a waveguide portion of the optical device, said optical fibre alignment structure being arranged to guide an end of an optical fibre into alignment with the waveguide portion,
(b) continuing insertion of said optical fibre such that the end of said optical fibre is guided by said optical fibre alignment structure, until the end of said optical fibre is aligned with the waveguide portion of the optical device.

8. A method of optically coupling an end of an optical fibre to an optical device as claimed in claim 7 wherein the method includes the additional step of affixing said fibre in the attained position.

9. A method of optically coupling an end of an optical fibre to an optical device as claimed in claim 7 wherein the method additionally includes the step of hermetically sealing a void between the optical fibre alignment structure and the optical fibre.

10. A method of optically coupling an end of an optical fibre to an optical device as claimed in claim 7 wherein step (a) is preceded by the additional step of inserting the end of said optical fibre in a fibre support sleeve or ferrule.

11. A method as claimed in claim 7 wherein said optical coupling is adjusted so as to prevent feedback effects from reflections at the fiber/waveguide interface.

12. An integrated optical device including an optical fibre alignment structure fabricated using a method as claimed in claim 1.

13. An optical fibre alignment assembly for aligning and optically coupling an end of an optical fibre to a planar optical device, the alignment assembly comprising a substrate, an aperture formed through said substrate for receiving said optical fibre therein, and an end-receiving structure shaped to receive an end of said optical fibre inserted through said aperture and to align said optical fibre end with respect to a waveguide portion of said optical device.

14. An optical fibre alignment assembly as claimed in claim 13 wherein said end-receiving structure comprises an inwardly tapered side wall for urging alignment of an optical fibre with said waveguide portion.

15. An optical fibre alignment assembly as claimed in claim 13 wherein said end-receiving structure comprises formations complimentary to formations on an end of an optical fibre to be received by said structure.

16. An integrated optical structure comprising a substrate, an optical device formed on said substrate. an aperture formed through said substrate for receiving an optical fibre therein and an end-receiving structure shaped to receive an end of an optical fibre inserted through said aperture and to align said optical fibre end with a waveguide portion of said optical device.

17. An integrated optical structure as claimed in claim 16 wherein said optical device includes a coupling structure adapted to couple light between said optical fibre and said waveguide.

18. An integrated optical structure as claimed in claim 17 wherein said integrated optical device structure includes one or more of a group comprising:
a metallised mirror; a partially transmissive mirror; a MEMS switch element; an electro-optic polymer material; a polymer filter; space switch; a grating; or thin film dielectric material.
